(19) United States
(12) Patent Application Publication
(10) Pub. No.: US 2024/0326369 A1
(43) Pub. Date: Oct. 3, 2024

(54) METHOD AND DEVICE FOR ASSESSING THE STATE OF A PRESSING PUNCH

(71) Applicant: Fette Compacting GmbH, Schwarzenbek (DE)

(72) Inventors: Sven Vulp, Klein Pampau (DE); Janis Herrmann, Wismar (DE); Jan Naeve, Kehrsen (DE); Timo Jasper, Schwienau (DE)

(73) Assignee: Fette Compacting GmbH, Schwarzenbek (DE)

(21) Appl. No.: 18/620,903

(22) Filed: Mar. 28, 2024

(30) Foreign Application Priority Data
Mar. 30, 2023 (DE) DE102023108106.3

(51) Int. Cl. B30B 15/28; B30B 15/14; G01N 21/88

(52) U.S. Cl. CPC B30B 15/28; B30B 15/148; G01N 21/8851; G01N 2021/8887

(57) ABSTRACT

A method for assessing the state of a pressing punch of a rotary includes providing the pressing punch having a punch head configured to interact with a pressure apparatus of the rotary press during operation and a punch tip arranged at another end of the punch shaft and configured to press a material in a cavity of a die plate of the rotary press. An image of at least one portion of the pressing punch is recorded using a camera. The recorded image is transmitted to an evaluation apparatus. A state analysis of the at least one portion is performed by the evaluation apparatus using an image processing algorithm. A state of the pressing punch is assessed by the evaluation apparatus based on the state analysis. A warning signal is output when the assessed state of the pressing punch is outside of a permissible range.

### CROSS REFERENCE TO RELATED INVENTION

This application is based upon and claims priority to, under relevant sections of 35 U.S.C. § 119, German Patent Application No. 10 2023 108 106.3, filed Mar. 30, 2023, the entire contents of which are hereby incorporated by reference.

### FIELD OF TECHNOLOGY

The foregoing disclosure relates to a method for assessing the state of a pressing punch of a rotary press, wherein the pressing punch has a punch shaft, on one end of which a punch head is arranged, which interacts with a pressure apparatus of the rotary press during operation, and on the other end of which a punch tip is arranged, which presses a material in a cavity of a die plate of the rotary press to form a pellet during operation. The disclosure is also directed to a device for performing the method.

### BACKGROUND

In rotary presses, a large number of upper and lower pressing punches are generally provided which are in each case assigned to one cavity of a die plate in pairs. During operation of the rotary press, the upper and lower pressing punches rotate together with the die plate, wherein their axial movement is controlled by means of control cams and is guided by means of upper and lower punch guides. During the course of the rotation, the die plate travels through various apparatuses of the rotary press, such as a filling apparatus and a pressure apparatus. The filling apparatus dispenses material to be pressed, in particular powder material, is filled into the cavities of the die plate, and a pressure apparatus includes the upper and lower pressing punches which are pushed into the cavities in particular by means of upper and lower pressure rollers in order to press the material into pellets, for example tablets. After the pressure apparatus, the upper pressing punches are guided upward out of the cavities and the pellets produced in the cavities are pushed by the lower pressing punches onto the upper side of the die plate. By means of a scraper, for example, the pellets are then scraped off of the die plate into an output of the rotary press, from where they are supplied for further processing.

Rotary presses are operated at high rotor speeds and correspondingly high production speeds. During the large number of pressing processes, the pressing punches become worn. In addition to wear of the punch heads due to their interaction with the pressure rollers, wear of the punch tips that press the material in the cavities also occurs, for example, due to abrasive material or other wear scenarios. Wear or damage to the punch tips can lead to unacceptable specifications of the pellets produced.

It is known to analyze and assess the wear on the punch heads using pressing force curves. Wear on the punch tips can only be assessed with difficulty or not at all with this method. The reason is that wear on the punch tip, for example, a chance of a radius of the punch tip or of a flattened edge of the punch tip, has only a minor effect on the pressing force curve. However, such changes to the punch tip have a significant influence on the production process of the pellets and thus on their quality.

It is typical to judge the state of pressing punches by visual examination. However, this assessment method is imprecise and depends on the operator making the assessment. It is difficult to define suitable objective criteria for assessing the state of the pressing punches and, if applicable, for replacing them. Manual inspection methods are associated with a significant time investment. In practice, an unsatisfactory state of the pressing punches, for example, their punch tips, is often only noticed when production problems occur or when the quality of the pellets produced is unsatisfactory. Furthermore, real-time monitoring of the pressing punches, in particular of the punch tips, is not possible in this manner.

A method for inspecting pressing punches is known from U.S. Pat. No. 10,598,605 B2, in which a pressing punch is placed into a punch holder. In the state in which it is held in the holder, the pressing punch is scanned, on the one hand, by means of an LED micrometer and, on the other hand, by means of a laser sensor. Various geometric parameters of the scanned pressing punch are detected with the LED micrometer and the laser scanner and are compared with tolerance ranges. On this basis, a pass or fail status is assigned to the parameters. However, scanning each point of the surfaces to be inspected of the pressing punch is associated with significant effort. The sensors used in U.S. Pat. No. 10,598,605 B2 are also costly.

Proceeding from the explained prior art, the object of the invention is therefore to provide a method and a device of the type mentioned at the outset, with which the state of a pressing punch can be assessed in a reliable, simple, and cost-effective manner.

### BRIEF SUMMARY OF THE INVENTION

An embodiment of a method for assessing the state of a press punch includes recording an image at least one portion of the pressing punch using a camera. The recorded image is supplied to an evaluation apparatus. The evaluation apparatus performs a state analysis of at least one portion of the pressing punch by means of an image processing algorithm and assesses the state of the pressing punch on the basis of the state analysis. If the state of the pressing punch assessed by the evaluation apparatus is outside of a permissible range, the evaluation apparatus outputs a warning.

An embodiment of a device configured to assess the state of a press punch includes a camera configured to record an image of at least one portion of a pressing punch and an evaluation apparatus in communication with the camera and configured to perform a state analysis of the at least one portion of the pressing punch by means of at least one image processing algorithm and to assess the state of the pressing punch on the basis of the state analysis. The evaluation apparatus outputs a warning if the state of the pressing punch assessed by the evaluation apparatus is outside of a permissible range or predetermined range.

The basic structure of a rotary press, in which the pressing punch assessed according to the invention is used, was explained at the outset. Accordingly, a rotary press typically comprises a plurality of upper and lower pressing punches, which each press the, in particular pulverulent, material in cavities of the die plate to form pellets, in particular tablets. The pressing punches have multiple portions, in particular a punch shaft, on one end of which a punch head is arranged, which interacts with a pressure apparatus of the rotary press, in particular the pressure rollers during operation, and on the other end of which a punch tip is arranged, which presses the material in the cavity of the die plate during operation. The design of the punch tips depends on the shape and size of the pellets to be produced. For different rotary presses or, respectively, different pellets to be produced, different pressing punches with in particular differently shaped and/or dimensioned punch tips are used.

The end face of the punch tip of the pressing punches, which is particularly relevant in terms of wear, can have in its outer region an annular flat portion, which is arranged in particular in a plane perpendicular to the longitudinal axis of the punch shaft. The annular flat portion surrounds a concave contour forming the pellet to be produced. The annular flat portion is intended to reinforce the outer edge of the end face of the punch tip and protect the contour forming the pellet particularly in its edge region from wear or damage so that the desired pellet geometry is generated at all times. The width of the annular flat portion is usually in a range of less than 1 mm, in particular less than 0.5 mm. This narrow annular flat portion is subjected to particular loads during operation of the rotary press and is thus particularly susceptible to wear or damage.

The invention is initially based on the idea of recording an image or, respectively, photo of at least one portion of the pressing punch, for example, the end face of the punch tip, the punch head, and/or the punch shaft, by means of a camera, in particular a digital camera. The recording can take place in particular in a plan view, meaning in the axial direction of the punch shaft, onto the punch tip and/or onto the punch head. The camera can function in the visible wavelength range or, for example, in the infrared range. It can comprise, for example, a two-dimensional CMOS or CCD sensor. The recorded digital image is given to an evaluation apparatus. The evaluation apparatus performs a state analysis of the recorded portion, and thus of the pressing punch. To do so, the evaluation apparatus processes the recorded image with an image processing algorithm or, respectively, applies an image processing algorithm to the recorded image. Corresponding software can be stored in the evaluation apparatus. A permissible range for specific parameters assessed as part of the state analysis can be defined, for example, by an operator or also by the evaluation apparatus. If this permissible range is departed from, a warning is output by the evaluation apparatus in the form, for example, of a visual and/or acoustic signal and/or in the form of a message to an operator, for example, on a display or through an app on a PC, laptop, tablet, or smartphone. The state assessed by the evaluation apparatus can be in particular a wear state of the at least one portion or, respectively, of the pressing punch. As explained, during operation of a rotary press, wear of the punch tip occurs, for example, due to abrasive material being pressed. Damage to the surface of the punch tip, in particular the end face, such as scratches, bumps, or other deformations, can also be detected and assessed as part of the state analysis according to the invention. The same applies to the punch head or the punch shaft. Real-time monitoring of the pressing punches is also conceivable. Furthermore, an automatic assessment of the pressing punches by the evaluation apparatus in conjunction with the camera can also be realized. The state assessment takes place in particular independently of an individual examination by an operator. At the same time, the method according to the invention or, respectively, the device according to the invention can be realized more cost-effectively than the use of a laser scanner proposed in the prior art. Using image processing algorithms ensures a reliable assessment of the state of the pressing punches. Thus, according to the invention, quality characteristics of the pellets produced are sustainably optimized, process stability is improved, and unplanned downtimes in the operation of the rotary press are minimized in a simple and reliable manner.

All upper and/or lower pressing punches of the rotary press can be assessed in the manner according to the invention. The evaluation apparatus can display the results of the state analysis to an operator. The evaluation apparatus can also comprise an input apparatus, through which an operator can set parameters for the state analysis, for example, the permissible range for specific assessed parameters or the punch type to be assessed. Displaying the results of the state analysis or, respectively, input by an operator can take place on a display or, respectively, an input apparatus of the evaluation apparatus, of the rotary press, or of a separate device, for example, a PC, laptop, tablet, or smartphone. The display and the input can take place in particular through a corresponding application (app).

According to one embodiment, the state analysis by means of an image processing algorithm can comprise a comparison of the recorded image with at least one reference image. The at least one reference image can show a target state of the at least one portion, for example, of the punch tip or, respectively, its end face. Using the image processing algorithm, a comparison of the recorded image with one or multiple reference images can take place. Specific parameters can be compared, for example, an outer diameter of the end face of the punch tip, if present an inner diameter of an annular outer flattened region of the end face or an evenness of the end face, in particular the occurrence of irregular regions in the recorded image compared to the at least one reference image. The same applies, for example, to the punch head. A database of the reference images for the respective punch type, for example, the respective punch tip shape and/or size, can be created so that recorded images can be compared with reference images stored in the database. Through a direct comparison of the recorded images with reference images, edge breakage, for example, in the region of the punch tip can be detected quickly and reliably.

According to another embodiment, it can be provided that the at least one reference image is at least one reference image of the at least one portion of an unused pressing punch and/or that the at least one reference image is at least one reference image of the at least one portion of the pressing punch to be assessed before the last production process of the pressing punch to be assessed in the rotary press. Thus, a comparison with a new state of the pressing punches or a comparison with a previous state of the pressing punches can take place, in particular a state immediately before the last production process performed with the pressing punch in the rotary press or a state before multiple of the production processes previously performed with the pressing punch in the rotary press.

In general, the recorded image can be compared with reference images of exactly the pressing punch to be assessed. Thus, individual properties of the respective pressing punch can be assessed or, respectively, taken into account. However, it is also conceivable that the reference images are standard images of the punch type to be assessed.

In an embodiment, the recorded image and the at least one reference image can be processed by the evaluation apparatus by means of at least an image processing algorithm before the comparison. Various image processing methods that simplify further processing, for example, smoothing, grayscale transform, etc., can be used.

According to another embodiment, the state analysis by means of an image processing algorithm can comprise extracting a region of interest from the recorded image, wherein the region of interest is preferably the end face of the punch tip. By extracting what is known as a region of interest (ROI) from the recorded image, the edge region of the punch tip, for example, can be analyzed particularly reliably. The image to be evaluated is limited to the end face of the punch tip. Regions of the pressing punch, in particular of the punch shaft and, if applicable, of the punch head, that are visible behind it are not considered. This simplifies and accelerates the evaluation.

The recorded image can be a color image (RBG). The state analysis by means of an image processing algorithm can then, according to another embodiment, comprise a grayscaling of the color image. Furthermore, the state analysis by means of an image processing algorithm can comprise converting the recorded image into a binary image. The binarization can take place with an adaptive threshold. The grayscale transform and the binarization make finding optical characteristics in the recorded image that are relevant to the wear state easier. It is also possible that the binary image comprises floating decimal places between 0 and 1.

As already explained, the at least one portion of the pressing punch recorded by the camera can be the end face of the punch tip of the pressing punch. The state analysis by means of an image processing algorithm can then, according to another embodiment, comprise determining a center point of the recorded end face of the punch tip. When a center point is mentioned in this context, it is in particular the geometrical center point or, respectively, geometrical center, since the end face is not necessarily circular. Furthermore, the state analysis by means of an image processing algorithm can comprise transforming the coordinates of the recorded image into a polar coordinate system. In order in particular to assess a flat annular region on the outside of the punch tip, it can be useful to transform the recorded image into polar coordinates, and for this purpose first to determine the center point of the end face of the punch tip.

According to another embodiment in which the end face of the punch tip has an annular flat portion in its outer region as explained above, the state analysis by means of an image processing algorithm can comprise identifying an outer and inner border of the annular flat portion. The lines delimiting the annular flat portion, which are, for example, circular in the recorded image, appear in the ideal case as parallel lines after the transformation into polar coordinates. This considerably simplifies the evaluation with regard to the borders of the annular flat portion by means of an image processing algorithm. Accordingly, the state analysis by means of an image processing algorithm can comprise determining a distance between the outer and inner border over the circumference of the annular flat portion. This distance can be determined very simply in terms of evaluation technology over the circumference in particular after the transformation into polar coordinates by determining the pixels on the processed recorded image along an axis transverse to the parallel lines representing the borders. The main maxima occurring in the recorded image that has been processed in this way represent the inner and the outer edge of the annular flat portion of the end face of the punch tip. Accordingly, the outer and inner border of the annular flat portion can be identified by determining maxima in the image processed as part of the state analysis. The evaluation of the distance can take place in a simple manner from the difference of the occurring main maxima before or after a retransformation of polar coordinates into Cartesian coordinates. However, it is, of course, also possible to determine the outer and inner border of the annular flat portion in Cartesian coordinates without determining the center point and transforming into polar coordinates, in particular by determining the pixels forming the borders, for example, on an array sensor. The determined distance values between the outer and inner border of the annular flat portion over the circumference of the end face of the punch tip can be compared, for example, with target values for the distance. If individual or multiple distance values determined over the circumference deviate unreliably from the target values, increased wear or damage to the annular flat portion or, respectively, its outer edges can be inferred by the evaluation apparatus. It is also conceivable to determine a fluctuation margin of the distance values determined through the circumference, for example, a minimum and a maximum distance value. If the fluctuation margin exceeds a permissible range, increased wear or damage to the flat annular portion and thus to the punch tip can be inferred.

When an annular portion is mentioned in this context, this includes not only circular portions, but also other annular geometries, such as oval or oblong annular portions, or also non-round ring shapes, for example, angular or, respectively, polygon-shaped annular portions.

According to another embodiment, the state analysis by means of an image processing algorithm can comprise applying a Canny algorithm to the recorded image. By means of a Canny algorithm, image information that is not relevant to the assessment of the state can be effectively filtered out of the recorded image, for example, light reflections from light sources provided for illuminating the at least one portion or the like. This simplifies the further state analysis.

For example, on the basis of using a Canny algorithm, the state analysis by means of an image processing algorithm can comprise detecting anomalies on the at least one portion of the pressing punch, for example, on the end face of the punch tip. Anomalies are deviations from an expected state, for example, surface defects, so that the surface partially deviates from an expected, for example, planar or concave shape. Typically occurring anomalies can be scratches, cracks, indentations, etc. An image processing algorithm for cluster analysis can also be used to detect anomalies. With this, anomalies are assessed as critical in particular when they occur frequently at one location or in one region. For example, in addition to the edge width of an annular flat portion of the of the punch tip, in particular the punch tip face overall, in particular the face of the usually concave recess for forming the pellet to be produced, can also be inspected by means of image processing algorithms. For this purpose, for example, after extracting a region of interest and, if applicable, grayscaling and, by way of further example, smoothing of the recorded image, anomalies can be detected on the image processed in this way. For example, it would be possible, after smoothing the image, to evaluate anomalies that were formed, for example, by scratches, cracks, or indentations in the punch tip using a DBSCAN (density-based spatial clustering of applications with noise) algorithm. In this manner, particularly serious defects in the punch tip, which lead to a corresponding defect in the pellets produced, can be reliably detected early so that the affected pressing punches can be identified and, for example, replaced.

According to another embodiment, the state analysis can be performed by means of machine learning algorithms. In particular, a self-learning algorithm that continuously optimizes the criteria for the assessment of the state of the pressing punches, in particular the punch tip, on the basis of training data and/or empirical data from previous assessment processes. Limit values for a deviation of parameters determined as part of the image processing according to the invention from target parameters can also be optimized during operation by means of self-learning software of this kind based on training data or empirical data. The machine learning algorithms may, for example, comprise neural networks.

According to another embodiment, it can be provided that the pressing punch to be assessed is mounted in the rotary press while the method is being performed or that the pressing punch to be assessed is held in a holder outside of the rotary press, in particular in a washing apparatus for the pressing punches of the rotary press, while the method is being performed. The camera can also be held on a supporting arm that can be moved into a pressing space of the rotary press or into a washing apparatus for the pressing punches. To assess the pressing punches of the rotary press, the rotor can be rotated, for example, successively such that the at least one portion, for example, the end faces of the punch tips, of the pressing punches of the rotary press are recorded by the camera one after another. In this manner, an assessment of all the pressing punches is possible. For this purpose, the supporting arm can be rotated, for example, by 360°, so that the upper and the lower pressing punches of the rotary press can be recorded one after another. With the aforementioned embodiments, a largely automatic state analysis of all pressing punches is possible, in the state installed in the rotary press or in a state removed from the rotary press. It is also conceivable to integrate the camera used according to the invention into an additionally provided tactile measuring system for detecting geometric parameters of the pressing punches. The supporting arm, for example, can be part of a robot so that an automatic control of the supporting arm for performing the state analysis can take place. This can also be controlled by the evaluation apparatus.

The method can also be carried out in a separate measuring device in that punches are brought, individually or in a set of punches, into a support seat of the measuring device provided for this purpose. The support seat is positioned so that it is possible to record images with the camera. It is located, for example, in a light tent. If a set of punches is to be measured, each punch is held, for example, in a support seat with connectors for each of the punches. This structure enables images of individual punches to be recorded without removing them from the support seat. For this purpose, the support seat is positioned in a fixed manner, for example, in the mentioned light tent using a holder or the like, while the camera is moved to each individual punch to record images.

Integrating the method according to the invention into a washing apparatus for pressing punches of the rotary press can provide additional advantages. On the one hand, the pressing punches are regularly accommodated in a holder in the washing apparatus and thus fixed in their position (GMP environment), which makes recording the images of the end face of the punch tip easier. In addition, by recording the images in a washing apparatus, problems are avoided that can arise in a pressing space of a rotary press, for example, due to existing product dust. If the washed punches are even polished before the state assessment according to the invention, additional parameters that could potentially alter the state assessment can be reliably precluded. For example, when integrated into a washing apparatus, a camera image of the at least one portion can be taken before and/or after each washing cycle. When the method according to the invention is integrated into the rotary press, a camera image of the pressing punches can be taken and a corresponding state assessment can take place, for example, before each production process begins.

In an embodiment, the device includes a washing apparatus for pressing punches of a rotary press with a holder for holding the upper and/or lower pressing punches in a washing chamber further comprising a washing device for washing the upper and/or lower pressing punches, and comprising a device according to the invention. The washing apparatus can also comprise a polishing device for polishing the pressing punches.

The invention also relates to a rotary press, comprising a rotor that can be rotated by means of a rotary drive, wherein the rotor comprises an upper punch guide for upper pressing punches and a lower punch guide for lower pressing punches as well as a die plate arranged between the punch guides, wherein the pressing punches interact with cavities of the die plate, wherein the rotary press further comprises a filling apparatus by means of which powder material to be pressed is filled into the cavities of the die plate, and wherein the rotary press comprises a pressure apparatus having an upper pressure roller and a lower pressure roller, which interact with the upper pressing punches and with the lower pressing punches during operation powder material to be pressed in the cavities of the die plate, and comprising a device according to the invention.

With the method according to the invention and the device according to the invention, it is also possible to record components additionally arranged on a pressing punch, for example, bellows or dust protection caps, with the camera and evaluate the recorded images in the manner according to the invention. In this manner, the state of such further components can also be assessed in the manner according to the invention.

### BRIEF DESCRIPTION OF THE DRAWINGS

Exemplary embodiments of the invention are explained below in greater detail using figures. They show schematically:

FIG. 1 illustrates a side view of an embodiment of a pressing punch of a rotary press.

FIG. 2 illustrates a close-up enlarged view of the embodiment of FIG. 1.

FIG. 3 illustrates a plan view of the embodiment of FIG. 2.

FIG. 4 illustrates a side view of an embodiment of a device for assessing the state of the pressing punch shown in FIGS. 1-3.

FIG. 5A show a diagram illustrating the state analysis according to the invention.

FIG. 5B shows another diagram illustrating the state analysis according to the invention.

FIG. 6A shows another diagram illustrating the state analysis according to the invention.

FIG. 6B shows another diagram illustrating the state analysis according to the invention.

FIG. 7 shows another diagram illustrating the state analysis according to the invention.

FIG. 8 shows another diagram illustrating the state analysis according to the invention.

FIG. 9 shows another diagram illustrating the state analysis according to the invention.

FIG. 10 shows another diagram illustrating the state analysis according to the invention. The same reference signs refer to the same objects in the figures unless indicated otherwise.

### DETAILED DESCRIPTION OF THE INVENTION

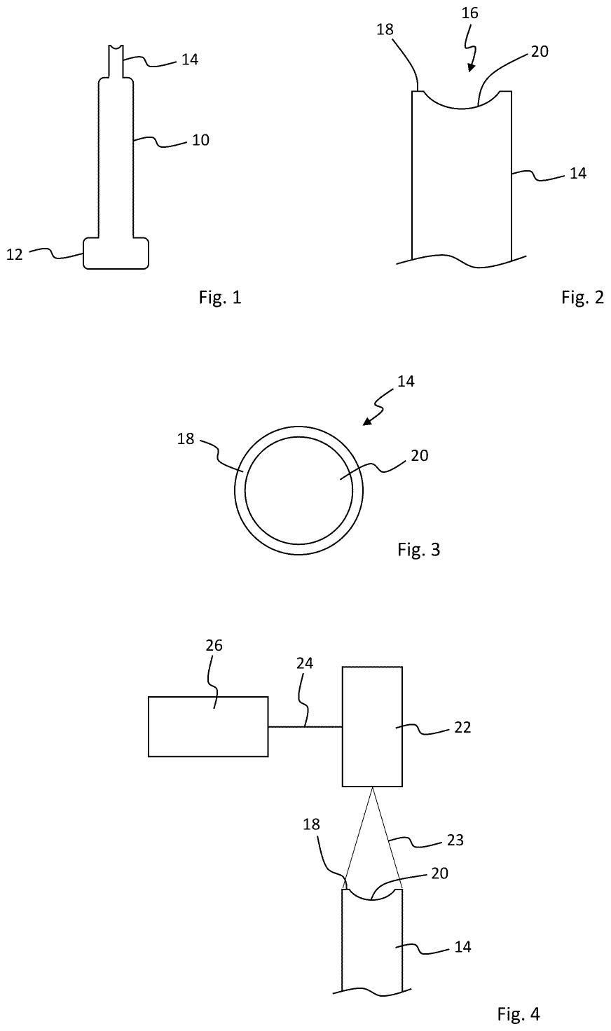

Referring to FIG. 1, a pressing punch of a rotary press is shown very schematically. The pressing punch comprises a, for example, substantially cylindrical, punch shaft 10, on the end of which a punch head 12 is arranged, which interacts with a pressure apparatus, in particular pressure rollers, of the rotary press during operation. On the opposite end of the punch shaft 10, a punch tip 14 is arranged, which is inserted into a cavity of a die plate of the rotary press during operation and presses powder material that is filled into the cavity in interaction with the punch tip of an opposing pressing punch to form a pellet, in particular a tablet. In FIG. 2, an enlarged representation of a portion of the punch tip 14 is shown. It can be seen here that the punch tip 14 has in the outer region of its end face 16 (pressing face) an annular flat portion 18 (edge width), which lies in a plane perpendicular to the longitudinal axis of the punch shaft 10 running vertically in FIG. 2. In FIG. 3, the punch tip 14 of FIG. 2 is shown in a plan view. The annular flat portion 18 can have, for example, a round or oval shape. It delimits a central concave portion 20 (pressing face without edge width), which forms the outer shape of the pellet produced during operation of the rotary press. The further pressing punch assigned opposite in pairs to the pressing punch shown in FIGS. 1 to 3 may be identically configured so that the annular flat portions 18 of the opposing pressing punches abut each other during operation when pressing the powder material.

During operation, wear or damage of, for example, the end face 16 of the punch tip 14 can occur, especially of the narrow and therefore relatively sensitive annular flat portion 18, due, for example, to abrasive powder material or for other reasons.

In FIG. 4, a device according to the invention for assessing the state of the pressing punch, in particular of the punch tip 14, is shown, wherein, for reasons of clarity, again only a portion of the punch tip 14 is shown enlarged. The device comprises a camera 22, in particular a digital camera 22, comprising, for example, a two-dimensional CMOS or CCD array sensor, with which an image of the end face 16 of the punch tip 14 is recorded in a plan view, as illustrated in FIG. 4 by the schematically drawn field of view 23. The recorded image is supplied to an evaluation apparatus 26 through a wired or wireless connection 24. The evaluation apparatus 26 performs a state analysis of the punch tip 14 of the pressing punch by means of at least one image processing algorithm and assesses the state of the pressing punch on the basis of the state analysis. For this purpose, at least one image processing algorithm is applied to the image recorded by the camera 22. For this purpose, corresponding software is stored in the evaluation apparatus 26. The evaluation apparatus 26 can also comprise a display and/or operating apparatus for displaying, for example, warnings if the state of the pressing punch assessed by the evaluation apparatus 26 is outside of a permissible range, and/or for inputting evaluation parameters by an operator. It is also possible that the evaluation apparatus 26 communicates with an external device, for example, a PC, a laptop, a tablet, or a smartphone, on which, for example, an app for displaying and inputting data of the evaluation apparatus 26 can be stored.

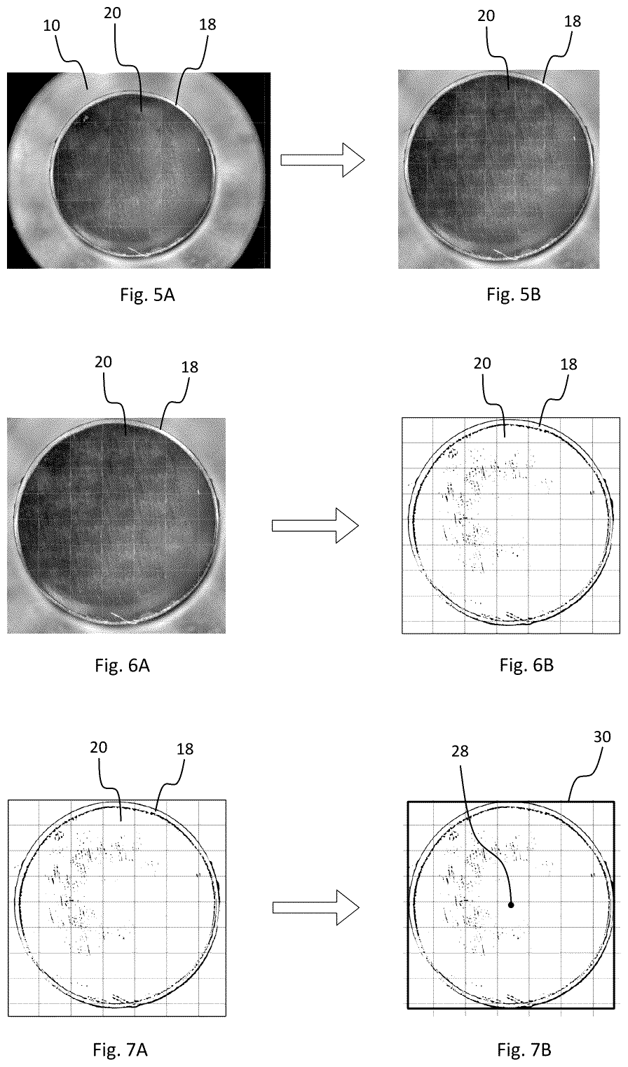

The evaluation of the image recorded by the camera 22 by means of at least one image processing algorithm will be explained in more detail using FIGS. 5 to 10. FIG. 5A shows an exemplary image of the end face 16 of the punch tip 14 recorded by the camera 22. In addition to the end face 16 with its annular flat portion 18 and the concave portion 20, the punch shaft 10 can also be seen outside the focus of the camera 22. In a first evaluation step, the evaluation apparatus 26 extracts the end face 16 of the punch tip 14 from the image in FIG. 5A as a region of interest by means of an image processing algorithm, as shown in FIG. 5B.

In FIG. 6A, the processed image from FIG. 5B is shown. In a further evaluation step, the evaluation apparatus 26 performs a grayscaling and conversion of the image in FIG. 6A into a binary image, which is shown in FIG. 6B, by means of an image processing algorithm.

This binary image, shown again in FIG. 7A, is further processed by the evaluation apparatus 26 by means of an image processing algorithm so that the center point 28 of the annular flat portion 18, and thus of the end face 16 of the punch tip 14, and a rectangle 30 delimiting the annular flat portion 18 are determined.

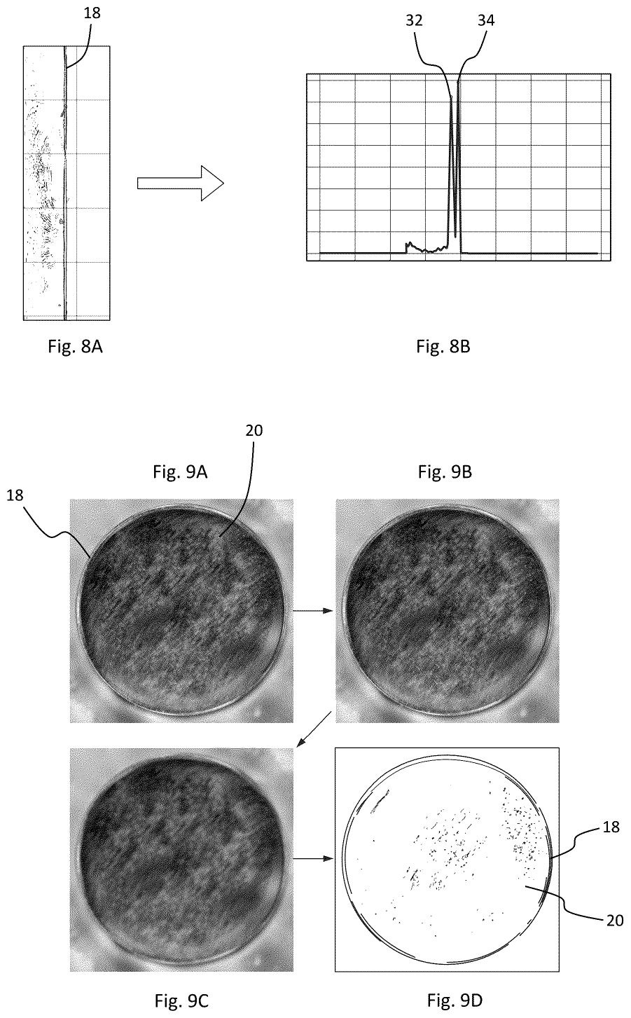

Then, the processed image shown in FIG. 7B is transformed into polar coordinates, as shown in FIG. 8A, by the evaluation apparatus 26 by means of an image processing algorithm. The inner and outer borders of the annular flat portion 18, which are substantially circular in FIGS. 7A and 7B, now appear as straight lines, which in the ideal case are parallel. As shown in FIG. 8B, two intensity maxima 32, 34, the distance of which corresponds to the distance of the inner and outer border, and thus the width of the annular flat portion 18, result in the x-direction, meaning from left to right in FIG. 8B. In that the evaluation apparatus 26 determines the maxima 32, 34 shown in FIG. 8B one after another over the Y-axis, meaning from bottom to top in FIG. 8B by means of an image processing algorithm, the distance between the inner and outer border of the annular flat portion 18 can be determined over the entire circumference of the annular flat portion 18.

With the state analysis by means of an image processing algorithm, as explained using FIGS. 5A to 8B, the state of the annular flat portion 18 and in particular any edge defect of this portion 18 can be determined reliably and simply. The determined parameters, such as the distance between the inner and outer border of the annular flat portion 18, can thus be compared with tolerance ranges and a warning signal can be output in the explained manner when a permissible range has been departed from.

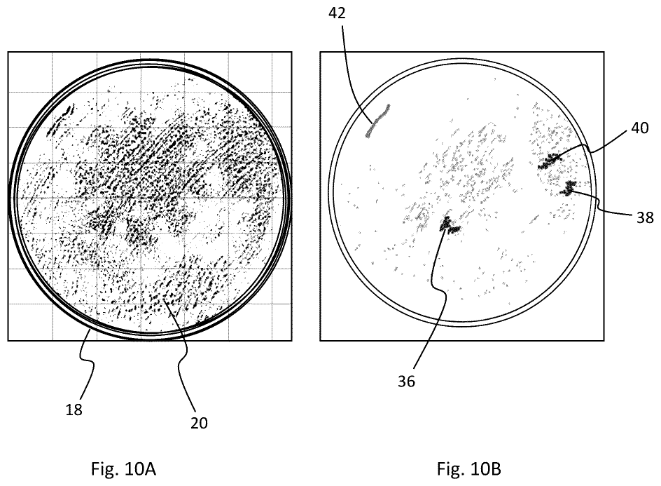

Using FIGS. 9A and 10B, an additionally or alternatively possible state analysis by means of at least one image processing algorithm by the evaluation apparatus 26 will be explained, with which the surface state of the end face 16 of the punch tip 14 can also be assessed.

Four views are shown in FIGS. 9A-D, wherein at FIG. 9A the image recorded by the camera 22 and reduced to the region of interest is again shown, as also shown in FIG. 5B. This image is converted into a grayscaled image by the evaluation apparatus 26 by means of an image processing algorithm, as shown in FIG. 9B. Furthermore, the evaluation apparatus 26 can perform a smoothing of the grayscaled image by means of an image processing algorithm, as shown in FIG. 9C. Then, a Canny edge image processing algorithm, for example, can be applied to the processed image by the evaluation apparatus 26. The result is shown in FIG. 9D. Anomalies can be seen on the surface of the end face 16 of the punch tip 14, which can be caused, for example, by scratches or similar surface defects. Accordingly, the evaluation apparatus 26 can detect these anomalies on the end face 16 of the punch tip 14 and output a warning about increased wear on the punch tip 14.

In FIG. 10A, a binary image generated by the evaluation apparatus 26 by means of an image processing algorithm from, for example, the grayscaled image shown in FIG. 9B is in turn shown. In this binary image, the inner and outer border of the annular flat portion 18 can again be determined by the evaluation apparatus 26 by means of an image processing algorithm. In addition, an image processing algorithm for cluster analysis can be applied by the evaluation apparatus 26 in order to detect anomalies on the surface of the end face 16 of the punch tip 14, as shown in FIG. 10B. A DBSCAN (density-based spatial clustering of applications with noise) algorithm, for example, can be used. The evaluation apparatus 26 can detect an accumulation of detected anomalies, meaning a cluster, as shown in FIG. 10 by way of example for four clusters 36, 38, 40, 42. These clusters 36, 38, 40, 42 can be assessed by the evaluation apparatus 26 accordingly as defects of the surface so that it can again output a warning.

The state analysis can be performed by the evaluation apparatus 26 using machine learning algorithms. For this purpose, training data in the form of images of end faces 16 of punch tips 14 that are within a permissible range and in the form of images of end faces 16 that are outside of the permissible range can be used.

Although the recording and evaluation of an image of the punch tips 14, in particular of their end faces 16, was explained using the figures, a recording of other portions of the pressing punches, for example, the punch head 12 and/or the punch shaft 10, with the camera can take place in the same manner and then be evaluated in the explained manner. Recording and assessing further components connected to the pressing punches, such as bellows or dust protection caps, is also possible in this manner, as explained.

### LIST OF REFERENCE SIGNS

10 Punch shaft
12 Punch head
14 Punch tip
16 End face (pressing face)
18 Annular flat portion (edge width)
20 Concave portion (pressing face without edge width)
22 Camera
23 Field of view
24 Connection
26 Evaluation apparatus
28 Center point
30 Rectangle
32 Maxima
34 Maxima
36 Cluster
38 Cluster
40 Cluster
42 Cluster

1. A method for assessing a state of a pressing punch of a rotary press, comprising:
providing the pressing punch comprising,
a punch shaft with a punch head arranged at one end of the punch shaft and configured to interact with a pressure apparatus of the rotary press during operation, and
a punch tip arranged at another end of the punch shaft and configured to press a material in a cavity of a die plate of the rotary press to form a pellet;
recording an image of at least one portion of the pressing punch with a camera;
transmitting the recorded image to an evaluation apparatus;
performing a state analysis of the at least one portion by the evaluation apparatus, wherein the state analysis is performed using an image processing algorithm;
assessing a state of the pressing punch by the evaluation apparatus based on the state analysis; and
outputting a warning signal when the assessed state of the pressing punch is outside of a permissible range.

2. The method according to claim 1, further comprising performing the state analysis using an image processing algorithm that comprises a comparison of the recorded image with at least one reference image.

3. The method according to claim 2, wherein the at least one reference image is at least one of:
at least one reference image of the at least one portion of an unused pressing punch; and
at least one reference image of the at least one portion of the pressing punch to be assessed before a last production process of the pressing punch to be assessed in the rotary press.

4. The method according to claim 1, further comprising performing the state analysis by extracting a region of interest from the recorded image, wherein the region of interest is an end face of the punch tip.

5. The method according to claim 1, wherein the recorded image is a color image, and wherein performing the state analysis using an image processing algorithm comprises a grayscaling of the color image.

6. The method according to claim 1, wherein performing the state analysis using an image processing algorithm comprises converting the recorded image into a binary image.

7. The method according to claim 1, wherein the at least one portion of the pressing punch is an end face of the punch tip of the pressing punch.

8. The method according to claim 7, wherein performing the state analysis using an image processing algorithm comprises determining a center point of a recorded end face of the punch tip.

9. The method according to claim 8, wherein performing the state analysis using an image processing algorithm comprises transforming coordinates of the recorded image into a polar coordinate system.

10. The method according to claim 7, wherein the end face of the punch tip comprises an outer region comprising an annular flat portion, and wherein the state analysis comprises identifying an outer and inner border of the annular flat portion.

11. The method according to claim 10, wherein the state analysis further comprises determining a distance between an outer and inner border over a circumference of the annular flat portion.

12. The method according to claim 11, further comprising identifying the outer and inner border of the annular flat portion by determining maxima in the image processed as part of the state analysis.

13. The method according to claim 1, wherein the state analysis comprises a Canny algorithm.

14. The method according to claim 1, wherein the state analysis comprises detecting anomalies on the at least one portion of the pressing punch.

15. The method according to claim 14, further comprising using an image processing algorithm for cluster analysis to detect anomalies on the at least one portion of the pressing punch.

16. The method according to claim 1, further comprising performing the state analysis using machine learning algorithms.

17. The method according to claim 1, wherein one of:
the pressing punch to be assessed is mounted in the rotary press during the assessment; and
the pressing punch to be assessed is held in a holder outside of the rotary press during the assessment, wherein the holder comprises a washing apparatus for the pressing punches of the rotary press.

18. The method according to claim 17, wherein the camera is held on a supporting arm that is configured to be moved into a pressing space of the rotary press.

19. The method according to claim 18, further comprising assessing the pressing punches of the rotary press by rotating a rotor successively such that the at least one portion of the pressing punches of the rotary press are recorded by the camera one after another.

20. A device for assessing a state of a pressing punch, comprising:
a camera configured to record an image of at least one portion of the pressing punch; and
an evaluation apparatus in electrical communication with the camera,
wherein the evaluation apparatus is configured to:
perform a state analysis of the at least one portion of the pressing punch using at least one image processing algorithm;
assess the state of the pressing punch based on the state analysis; and
output a warning signal if the state of the assessed pressing punch is outside of a stored permissible range.
